(19) United States
(12) Patent Application Publication
(10) Pub. No.: US 2003/0089447 A1
(43) Pub. Date: May 15, 2003

(54) Soft absorbent garment made with discretely coated elastic elements, and system and method for making a soft absorbent garment

(76) Inventors: Kenneth Molee, Suwanee, GA (US); Joseph B. Vergona, Suwanee, GA (US)

Correspondence Address: Christopher C. Campbell, Esq., Hunton & Williams, Suite 1200, 1900 K Street, NW, Washington, DC, 20006-1109, US

(21) Appl. No.: 09/985,885

(22) Filed: Nov. 6, 2001

(51) Int. Cl. B32B 27/12

(52) U.S. Cl. 156/161; 156/179; 428/114; 428/298.1; 156/436

(57) ABSTRACT

A softer absorbent garment is prepared by incorporating elastic strands that are coated around their periphery. The elastic strands are coated with adhesive by immersing them in an adhesive-filled applicator comb prior to applying the elastic strands to the garment. The absorbent garment thus requires less adhesive, and the manufacturing method provides a cleaner work environment.

### BACKGROUND OF THE INVENTION

1. Field of the Invention

The invention relates to the field of absorbent garments in general, and more particularly to an absorbent garment assembled with incorporated elastic elements that have been discretely coated with adhesive prior to their assembly into the body of the garment to create a softer article than previously known. The invention also relates to a system and method of making the absorbent garment.

2. Description of Related Art

Disposable absorbent garments such as infant diapers or training pants, adult incontinence products, and other such products are well-known in the art. Typically, the chassis of such garments comprises a liquid-permeable body-contacting liner sheet (or “topsheet”), a liquid-impermeable backing sheet (or “backsheet”) (collectively the “sheets”), and a moisture-absorbent core fiber (or “absorbent core”) that usually is made of a mat of randomly arrayed cellulose fiber and is generally disposed between the topsheet and the backsheet. These garments oftentimes incorporate elastic elements in the waist, tummy, and leg areas for improving the fit of the garment. The waist and tummy elastic elements increase the flexibility of the garment, allowing the same garment to accommodate a greater range of body sizes. In addition, they make the garment more form-fitting for the wearer. Leg gather elastic elements and standing leg gathers have also been employed to help reduce leakage of urinary and bowel movement (“BM”) from the garment when the absorbent cores cannot absorb body exudates fast enough. Leg gathers are known in the art, and U.S. Pat. No. 5,660,664 issued to Herrmann, the disclosure of which is incorporated by reference herein in its entirety, discloses an exemplary method of manufacturing leg gathers.

These garments typically are prepared by continuously supplying the various components of the garment, and forming these components into the final garment. The elastic elements are continuously supplied at several different points of the assembly process, and are coated with adhesive prior to bonding to the garment components.

Methods of bonding elastics to garment materials have been previously discussed in the art. An example of disposing elastic elements between layers of sheet material is given in U.S. Pat. No. 5,870,778 issued to Tharpe, the disclosure of which is incorporated by reference herein in its entirety. Tharpe discloses coating the garment materials with adhesive to affix the elastic elements therein. A common procedure for affixing elastic elements in the industry today is a spiral spray adhesive application as disclosed in U.S. Pat. No. 4,815,660, issued to Boger, the disclosure of which is incorporated by reference herein in its entirety. Spiral spray adhesive application consists of ejecting a bead of hot melt adhesive, directing jets of pressurized air to form an elongated adhesive fiber from the bead, and imparting a rotational motion to the adhesive fiber. The spirals of adhesive are then deposited on the target substrate, here elastic elements, which are then associated with the garment materials. In usage, the adhesive spray coats not only the elastic elements but also “oversprays” to other sites, causing a number of undesirable consequences.

First, the garment materials that are “oversprayed,” e.g., portions of the topsheet, the bottom sheet, and the absorbent core, become rigid upon hardening of the “oversprayed” adhesive making the garment less comfortable for its wearer. This has been referred to as the “plywood effect.” Second, the “overspray” coats parts of the assembly machinery that must then be periodically cleaned of the adhesive. Third, the elastic elements may not be uniformly coated with the adhesive due to the nature of the spraying operation, and therefore the elastic elements may not bond to the garment materials as well as if they had been more uniformly and completely coated with the adhesive. Finally, the “overspray” is wasted adhesive, increasing the cost of materials for the finished garment.

Previous attempts have been made to reduce the amount of excess adhesive that is applied to the garment, but these efforts have proved inadequate for reducing garment stiffening caused by the “plywood effect” and for reducing the cost of the garment due to excessive adhesive use. U.S. Pat. No. 5,993,433 issued to St. Louis et al., which is incorporated herein by reference in its entirety, discloses an adhesive pattern for applying adhesives to the gathers, but such adhesive patterns still contribute to excessive garment stiffness and cost. U.S. Pat. No. 6,235,137 issued to Van Eperen et al., which is incorporated herein by reference in its entirety, discloses a method of coating an elastic strand with a filament of adhesive, but this coating process is still subject to overspraying, and does not provide a complete coating of adhesive on the elastic.

Accordingly, there exists a need to manufacture a softer absorbent garment that has not had garment materials “oversprayed” with adhesive during the step of coating of the elastic elements for assembly. A need also exists for a cleaner, more cost effective method of applying adhesive to the elastic elements for assembly into absorbent garments. Additionally, a need exists to more uniformly and completely coat elastic elements with adhesive prior to bonding to an absorbent garment to promote product uniformity and improved adhesion of the elastic elements to the garment.

### SUMMARY OF THE INVENTION

A method and system for discretely coating elastic elements prior to their incorporation in absorbent garments, as well as a softer absorbent garment than previously known made from the described method and system, is disclosed.

The method includes moving one or more elastic strands at a predetermined speed in a first direction through an applicator comb. The applicator comb has a slot corresponding to each elastic strand. Adhesive is pumped or otherwise supplied or provided towards the elastic strands through the applicator comb at a predetermined temperature and flow rate. The adhesive is deposited onto the elastic strands to form an adhesive coating around substantially the entire periphery or circumference of each of the elastic strands. The elastic strands are applied to a first sheet, and a second sheet is applied to the first sheet such that the elastic strands are positioned between the first sheet and the second sheet.

In various preferred embodiments, the elastic strands may form tummy elastics, waist elastics, and/or gather elastics in the absorbent garment.

In another preferred embodiment, the adhesive supplying or pumping may be periodically discontinued such that portions of the elastic strands are not coated with adhesive.

In still another preferred embodiment, the first and second sheet may be joined to one another only by their mutual adhesion to the adhesive coating on the elastic strands.

These and other objects, features and advantages of the invention will be apparent through the detailed description of the preferred embodiments and the drawings attached hereto. It also is to be understood that both the foregoing general description and the following detailed description are exemplary and explanatory and are not restrictive of the scope of the invention.

### BRIEF DESCRIPTION OF THE DRAWINGS

The invention may be understood more readily by viewing the drawings, in which:

FIG. 1 depicts a garment according to a preferred embodiment of the invention as it appears when worn by a user, with portions of the garment partially cut away to show internal parts;

FIG. 2 is an exploded isometric view of the garment of FIG. 1 with the effects of the elastics removed for purposes of explanation;

FIG. 3 is a schematic plan view of another garment according to another preferred embodiment of the invention;

FIG. 4 is a partially cut away isometric view of an applicator comb according to a preferred embodiment of the invention;

FIG. 5 is an isometric view of another applicator comb according to a preferred embodiment of the invention;

FIG. 6A is a partial isometric view of the applicator comb of FIG. 4, showing a slot filled with adhesive;

FIG. 6B is a partial isometric view of the applicator comb of FIG. 4, showing an elastic strand passing through the slot and being coated with adhesive;

FIG. 7 is a diagram of a manufacturing line according to a preferred embodiment of the invention;

FIG. 8 is a partially cut away view of a portion of tummy elastic assembly manufactured according to a preferred embodiment of the present invention;

FIG. 9 is an isometric view of a cutting drum that may be used to fabricate a tummy elastic assembly manufactured according to a preferred embodiment of the present invention;

FIG. 10 is plan view of some of the manufacturing steps employed to manufacture the garment of FIG. 1; and

FIG. 11 is an exploded isometric view of a preferred embodiment of a comb applicator suitable for use with the present invention.

### DETAILED DESCRIPTION OF THE PREFERRED EMBODIMENTS

One significant advantage of the invention according to the preferred embodiments is that by discretely coating the elastic strands before bonding them to the sheets of the garment, the sheets are not inadvertently coated with adhesive which may occur when the adhesive is applied, for example, by spraying. The sheets therefore retain their original softness and pliability, rather than becoming partially rigid through adhesive “overspray” that typically stiffens these materials upon hardening of the adhesive.

A further advantage of the invention according to the preferred embodiments is that the elastic elements may be discretely coated (i.e., coated along discrete portions of their length while leaving other portions uncoated) with a higher accuracy as compared to conventional coating methods.

Another advantage of the invention according to the preferred embodiments is that the discretely coated elastic elements are more uniformly and completely coated with adhesive, resulting in more effective and uniform bonding of the elastic elements to the sheets of the garment. In one preferred embodiment where the elastics are attached between laminated sheets or within a fold of a sheet, no other bonding between the sheets may be necessary to maintain the integrity of the laminate or the fold.

Yet another advantage of the invention according to the preferred embodiments is a cost savings in adhesive, as the present system and method results in a nearly 60-65% reduction in the amount of adhesive required to produce an absorbent garment when compared to a garment manufactures using the conventional spraying techniques.

Yet another advantage of the invention according to the preferred embodiments is a cleaner work environment, and less cost for clean up of the assembly machinery as the adhesive is no longer errantly sprayed onto the assembly machinery or the surrounding work area. The reduction in clean-up requirements also provides reduced machine down-time, allowing for a greater overall machine production capacity and efficiency.

“Garment,” as used herein, refers to articles and garments that absorb and contain body exudates, and more specifically refers to articles and garments that are placed against or in proximity to the body of the wearer to absorb and contain the various exudates discharged from the user's body. A non-exhaustive list of examples of “absorbent articles” and garments includes diapers, diaper covers, disposable diapers, training pants, feminine hygiene products, and adult incontinence products. The invention can be used with all of the foregoing classes of absorbent articles and garments, without limitation, whether disposable or otherwise. Furthermore, the invention will be understood to encompass, without limitation, all classes and types of absorbent articles and garments, including those described above.

Absorbent garments and diapers may have a number of different constructions. In each of these constructions it is generally the case that an absorbent core is disposed between a liquid pervious, body-facing topsheet, and a liquid impervious, exterior backsheet. In some cases, one or both of the topsheet and backsheet may be shaped to form a pant-like garment. In other cases, the topsheet, backsheet and absorbent core may be formed as a discrete assembly that is placed on a main chassis layer and the chassis layer is shaped to form a pant-like garment. The garment may be provided to the consumer in the fully assembled pant-like shape, or may be partially pant-like and require the consumer to take the final steps necessary to form the final pant-like shape. In the case of training pant-type garments and most adult incontinent products, the garment is provided fully formed with factory-made side seams and the garment is donned by pulling it up the wearer's legs. In the case of diapers, a caregiver usually wraps the diaper around the wearer's waist and joins the side seams manually by attaching one or more adhesive or mechanical tabs, thereby forming a pant-like structure. For clarity, the present invention is described herein only with reference to a training pant-type garment in which the topsheet, backsheet and absorbent core are assembled onto a chassis layer that forms a pant-like garment, although the invention may be used with other constructions.

Although the various embodiments of the invention are described in the context of a training pant, it is readily apparent and understood that this is not intended to limit the invention. The present invention may be used with any other absorbent garment having elastics incorporated therein.

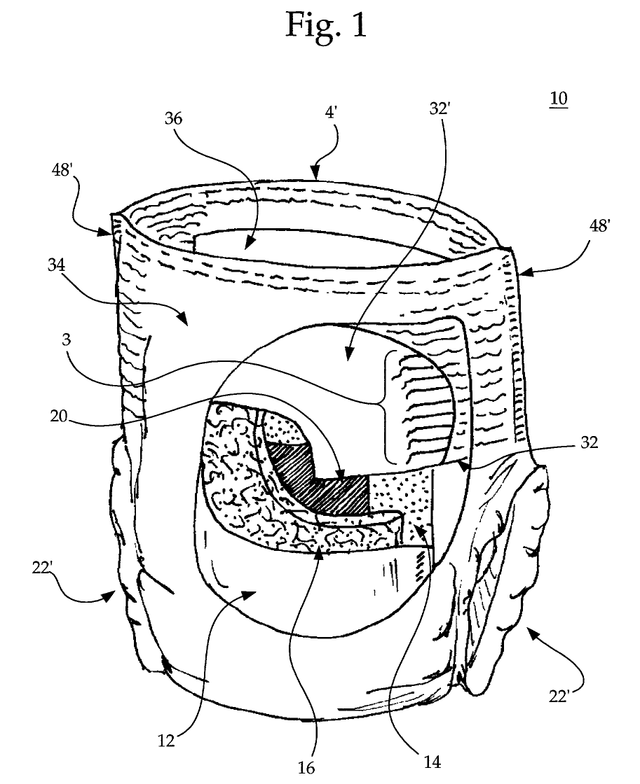

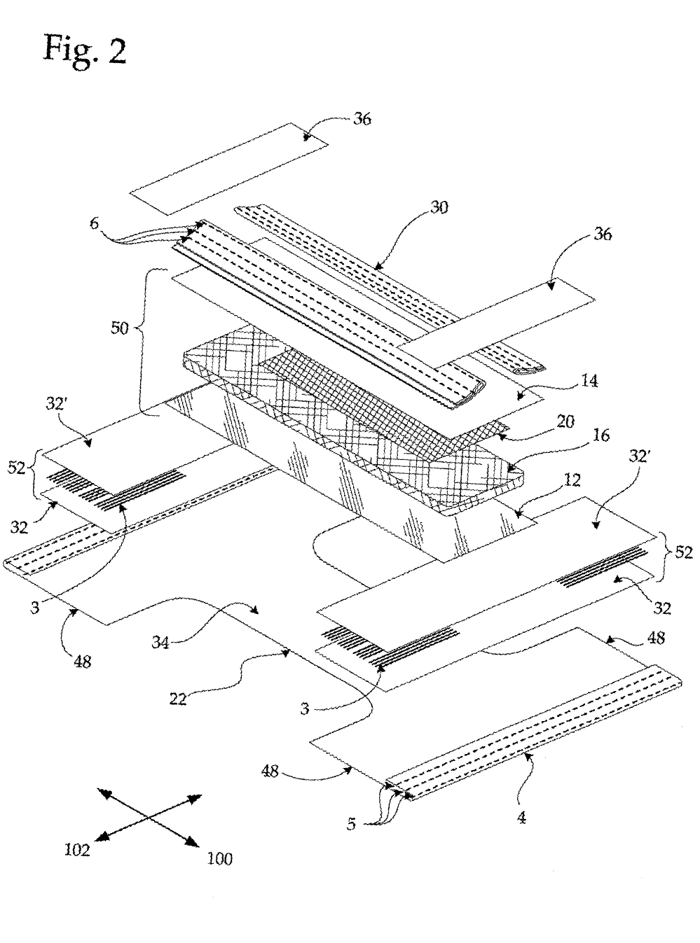

The present invention is described generally with reference to FIGS. 1 and 2. FIG. 1 depicts a preferred embodiment of the present invention as worn. FIG. 2 is an exploded view of a preferred embodiment of the present invention with elastic members shown in the elongated position for clarity, and the garment laid flat. The garment 10 has a longitudinal axis 100 corresponding approximately to the rear-to-front axis of the garment, as it appears when worn by an intended wearer, and a lateral axis 102, orthogonal to the longitudinal axis 100, and corresponding approximately to the side-to-side axis of the garment.

In the embodiment of FIGS. 1 and 2, the garment 10 comprises a main chassis layer 34 that forms a pant-like garment 10 having two leg holes 22′ and a waist encircling edge 4′. The pant-like structure may be formed by joining lateral edge portions 48 to one another to form side seams 48′. The lateral edge portions 48 may be joined during manufacture by any means known in the art or a combination of such means. Examples of such means include: adhesives such as hot melt adhesives and construction adhesives, chemical or solvent bonding, stitching, heat bonding, autogenous bonding, and, preferably, ultrasonic welding. The lateral edge portions 48 may also be joined by a user with the assistance of adhesive strips or mechanical fasteners (not shown). When the lateral edge portions 48 are joined, leg hole cutouts 22 along the lateral edges of the garment 10 form leg holes 22′, and the longitudinal ends 4 of the garment 10 form a waist encircling edge 4′.

A core assembly 50 is disposed on the interior of the chassis layer 34. The core assembly 50 may comprise an absorbent core 16 disposed between an exterior facing moisture impervious barrier film 12 or “backsheet,” and a moisture pervious body-contacting inner layer 14 or “topsheet.” Each of the backsheet 12, topsheet 14 and absorbent core 16 may comprise a plurality of layers of materials. In the embodiment depicted in FIG. 1, the backsheet 12, topsheet 14, and absorbent core 16 comprise a subassembly that may be attached to the chassis layer 34. It should be readily apparent that in another preferred embodiment, one or both of the topsheet 14 and backsheet 12 may be shaped to form the main body of a pant-like garment thereby eliminating the need for a separate chassis layer 34. In still another preferred embodiment of the invention, the backsheet 12, topsheet 14, and absorbent core 16 may be assembled and used without ever being shaped as a pant-like garment, such as when used as a feminine care product.

The chassis layer 34 may comprise a nonwoven polyethylene or polypropylene sheet or any other suitable garment material known in the art or hereafter discovered. All or part of the chassis layer 34 may comprise a liquid pervious or liquid impervious material or a may be zone-treated to be partially liquid pervious or impervious. The chassis layer 34 may be stretched in one or more directions during the manufacturing process, thereby reducing its elasticity in the direction of stretch.

The backsheet 12 may comprise a laminate of multiple layers of materials that have similar or different properties. The backsheet 12 is preferably made from a substantially liquid impervious material. The selection and manufacture of such materials is well known in the art, and is disclosed, for example, in U.S. Pat. No. 6,123,694 issued to Peniak et al., and U.S. Pat. No. 6,176,952 issued to Maugans et al., each of which is incorporated herein by reference in its entirety, and in a manner consistent with the present invention. In one embodiment, the backsheet 12 is made from a thin thermoplastic material, such as a pigmented polyethylene film having a thickness in the range of 0.02-0.04 mm. The backsheet 12 may also have a laminate construction comprising one or more layers of meltblown polypropylene or meltblown polyethylene, sandwiched between layers of spun-bonded material (often referred to as an “SMS” laminate). Additional layers may be added to the backsheet 12 in order to provide it with other desirable properties, such as to improve the tactile feel, or “hand.” The backsheet 12 may also be entirely or partly gas pervious to allow the garment to circulate air, or “breathe.”

The topsheet 14, which preferably overlays the backsheet 12, can be made from a substantially liquid pervious material to allow body exudates to penetrate into the absorbent core 16. The topsheet 14 may typically comprise a carded polyester fiber with a latex binder or a spun-bonded polypropylene having continuous fibers and thermally bonded by patterned calendar rolls. The topsheet 14 may be treated over all or part of its surface to render it hydrophilic, and may also be zone-treated with a surfactant to render it hydrophilic only in certain target areas. The topsheet 14 may also be treated with skin treating ingredients, such as aloe, vitamin E, and the like, which can be accomplished by a variety of methods known in the art. The topsheet 14 may also comprise an apertured material, such as an apertured film.

In one preferred embodiment of the present invention, one or more of the topsheet 14, backsheet 12 and chassis layer 34 may comprise a laminate of several layers of material, which may have different physical properties. In another embodiment, one or more of the topsheet 14, backsheet 12 and chassis layer 34 may comprise several pieces of material, which may have dissimilar physical properties, joined at or near their edges to form a multi-paneled sheet. Such an embodiment is disclosed, for example, in U.S. Pat. No. 5,275,590 issued to Huffman et al., which is incorporated herein by reference in its entirety, and in a manner consistent with the present invention.

In a preferred embodiment of the invention, the topsheet 14 and chassis layer 34 comprise nonwoven materials and the backsheet 12 comprises a film material. The topsheet 14, backsheet 12 and chassis layer 34 may also be made, however, from any other suitable material. In various embodiments, one or more of the topsheet 14, backsheet 12 and chassis layer 34 may be selected to provide particular benefits to the garment 10. For example, they may be selected to provide a good tactile impression, or “hand,” a comfortable fit, or gas permeability to improve the breathability of the garment 10.

The absorbent core 16 may be made from any absorbent material or materials known in the art. In one embodiment of the invention, the absorbent core 16 comprises wood fibers or other fibers such as chemical wood pulp, fibrous absorbent gelling material, or any other suitable liquid absorbing material, such as commercially available fluff pulp or fluffed bleached kraft softwood pulp or fibrous absorbent gelling material. In another embodiment of the invention, the absorbent core 16 comprises a combination of a porous fibrous web and super absorbent particles. Absorbent cores are known in the art and are disclosed, for example, in U.S. Pat. No. 5,281,207 issued to Chmielewski et al., U.S. Pat. No. 4,610,678 issued to Weisman et. al., U.S. Pat. No. 5,137,537 issued to Herron et. al., and U.S. Pat. No. 5,147,345 issued to Young et. al., which are incorporated herein by reference in their entirety, and in a manner consistent with the present invention. In such an embodiment, the absorbent core 16 may be surrounded by a liquid pervious tissue over-wrap (not shown), or other material.

The absorbent core 16 generally is elongated along the longitudinal axis 100 of the garment, and may extend along either or both of the lateral and longitudinal axes 102, 100 to the outer perimeter of the garment. In the embodiment depicted in FIGS. 1 and 2, the absorbent core 16 is substantially rectangular in shape, however, it may also have rounded ends or other shapes, such as an “I” shape or a “T” shape. The absorbent core 16 may also have channels, grooves or pockets, and may have a varying thickness.

The various parts of the garment 10 preferably are operatively associated with one another in such a manner that the garment will maintain its desired structure during use. The parts may be operatively associated with one another by a variety of methods known in the art, including, but not limited to: using adhesives such as hot melt adhesives and construction adhesives, chemical or solvent bonding, ultrasonic welding, stitching, heat bonding, autogenous bonding, or any other method of affixation known or hereafter discovered. U.S. Pat. No. 4,919,738 issued to Ball et. al. discloses a method of autogenous bonding, and its disclosure is herein incorporated by reference in its entirety in a manner consistent with the invention. All of the parts may be joined to each adjacent part, but some parts may not be joined to others. In one embodiment, the topsheet 14 and backsheet 12 are bonded to one another around their perimeter regions, thereby encasing and holding the absorbent core 16 in place without having to directly join the absorbent core 16 to any parts of the garment 10. The topsheet 14 or backsheet 12 may also be operatively associated with the absorbent core 16. As understood herein, the term “operatively associated” includes directly joining one part to another, indirectly joining parts together through one or more intermediary parts, whether those intermediary parts are described herein or not, joining parts in such a manner that unjoined parts are captured or held in their proper place, and any other suitable joining means that maintains the structural integrity of the garment 10 for the duration of its use.

In a preferred embodiment of the present invention depicted in FIGS. 1 and 2, the garment 10 further comprises various mechanisms for improving the garment's ability to contain body exudates, such as standing leg gathers 30. Standing leg gathers 30 may be formed by incorporating a plurality of gather elastics 6 into folds in the topsheet 14 or into additional ribbons 38 that are attached to the garment near the leg holes 22. The gather elastics 6 cause the standing leg gathers 30 to rise above the interior surface of the garment 10, thereby forming vertical curtains of material that help contain exudates. The ribbons 38 may be liquid pervious or liquid impervious, and more than one pair of opposing standing leg gathers 30 may be provided. The standing leg gathers 38 may be attached to the topsheet 14, backsheet 12, chassis layer 34 or any other suitable part of the garment so long as they are positioned in a manner that they block or impede the passage of fluids and other exudates. Additional elastics (not shown) may also be incorporated into the chassis layer 34, topsheet 14 or backsheet 12 adjacent the leg holes to form conventional (i.e., non-standing) leg gathers, as is known in the art. Conventional gathers contract the garment 10 around the wearer's legs and body to prevent leakage. U.S. Pat. Nos. 3,860,003 and 4,081,301 issued to Buell, U.S. Pat. No. 4,695,278 issued to Lawson, U.S. Pat. No. 4,808,177 issued to Des Marais, U.S. Pat. No. 4,795,454 issued to Dragoo, and U.S. Pat. No. 4,938,755 issued to Foreman illustrate other embodiments of leg cuffs and gathers in absorbent garments, and the disclosures of each of these patents are hereby incorporated by reference in their entirety, and in a manner consistent with the present invention.

The core assembly 50 may comprise additional layers of material that may reduce rewet of the topsheet 14, reduce strikethrough times or otherwise improve the absorbency, dryness and other properties of the garment 10. For example, a transfer layer 20 comprising an apertured film or an air-bonded carded, bicomponent fiber nonwoven, having a basis weight of about 20 g/m² to about 100 g/m², and more preferably about 30 g/m² to about 60 g/m², and most preferably about 40 g/m² may be disposed between the topsheet 14 and the absorbent core 16. Such multiple layer absorbent cores are known in the art and disclosed in U.S. Pat. No. 5,439,458 issued to Noel et al., which is incorporated herein by reference in its entirety, and in a manner consistent with the present invention.

The core assembly 50 may be attached to the chassis layer 34 by any means known in the art, such as by ultrasonic bonding or by the use of lines of hot melt adhesive. The bond between the core assembly 50 and the chassis layer 34 may be reinforced by laterally-extending end strips 36 that are applied over the longitudinal ends of the core assembly 50 and bonded to the underlying structure of the garment 10. The end strips 36 may also hold the ends of the standing leg gathers 30 so that the standing leg gathers 30 face inwardly. Such end strips 36 preferably comprise a fluid pervious nonwoven material, but may be fluid impervious or a material other than a nonwoven material. Such materials are known in the art. The end strips 36 may also help prevent the longitudinal flow of exudates past the ends of the core assembly 50, particularly if the edges of the nonwoven strips overlying the core assembly 50 are left unbonded so that they form pockets to hold exudates.

In other embodiments, adjustment strips (not shown) may be disposed on and partially attached to the garment to provide for an adjustable fit. Absorbent garments often loosen during use for various reasons, such as inelastic stretching of the various components, changes in user size, and increased loading caused by the introduction of body exudates into the garment 10. The adjustment strips may be formed such that they may be releasably attached to the garment 10 to reduce the circumference of the waist encircling edge 4′, and may comprise any fastening means known in the art or later discovered.

It is often desirable for an absorbent garment to contract around various parts of the wearer's body to provide improved comfort and exudate containment. In addition to the standing leg gathers 30 or conventional gathers, waist elastics 5 and tummy elastics 3 may be incorporated into the garment 10 to contract the garment 10 about the wearer's waist and stomach. Such elastics are typically stretched as they are joined to the garment 10 so that the contraction of the elastics causes the garment 10 to contract about the wearer. The elastics may also be applied in an unstretched state and then mechanically stretched to create an elasticized region in the garment (often called a zero-strain laminate). The elastics may also be applied in an inelastic state and then heat activated to cause them to be come elasticized. The elastics 3, 5, and 6 may be made from natural or synthetic rubber, elastomers, LYCRA® elastomer (available from E. I. DuPont de Nemours and Company, a business having offices in Wilmington, Del.), polyurethane, heat shrinkable polymer ribbons, or any other suitable elastic material or composite.

In a preferred embodiment, the waist elastics 5 are located proximal to one or both longitudinal ends 4 of the chassis layer 34, and are thereby located along the waist encircling edge 4′ of the fully assembled garment 10. In such an embodiment, the waist elastics 5 may be located on one side of the chassis layer 34, within a fold in the chassis layer 34 (as shown in FIG. 2), or otherwise fixed in the proximity of the longitudinal ends 4. U.S. Pat. No. 4,515,595 issued to Kievit et. al. and U.S. Pat. No. 4,816,025 issued to Foreman illustrate other embodiments of elasticized waist features of absorbent garments, and are hereby incorporated by reference in their entirety

Tummy elastics 3 may also be disposed in the garment 10 between the longitudinal ends 4 and the leg opening cutouts 22 to thereby be positioned across the wearer's stomach. The tummy elastics 3 may be attached directly to the chassis layer 34 or may be sandwiched between a pair of carrier layers 32, 32′ to form tummy elastic assemblies 52 which are attached to the chassis layer 34. The tummy elastics 3 may be located on the interior or exterior side of the chassis layer 34, and may be covered by additional layers of material. In a preferred embodiment, the tummy elastics 3 are affixed between a pair of carrier layers 32, 32′. The carrier layers 32, 32′ preferably comprise nonwoven materials, but may be made of any suitable material, and may be liquid pervious or liquid impervious. The carrier layers 32, 32′ are preferably gas pervious to allow the garment 10 to “breathe.”

In one embodiment, the tummy elastics 3 may extend across the entire width of the garment 10. In a preferred embodiment, shown in FIGS. 1 and 2, the tummy elastics 3 extend across the lateral sides of the garment 10, but not across the portion of the garment 10 overlying the absorbent core 16. Such a preferred embodiment may provide improved fit and comfort and improve the garment's appearance. U.S. Pat. No. 5,449,353 issued to Watanabe et. al. and U.S. Pat. No. 5,749,865 issued to Yamamoto et al. illustrate other embodiments of elasticized waist features of absorbent garments, and are incorporated herein by reference in their entirety, and in a manner consistent with the present invention.

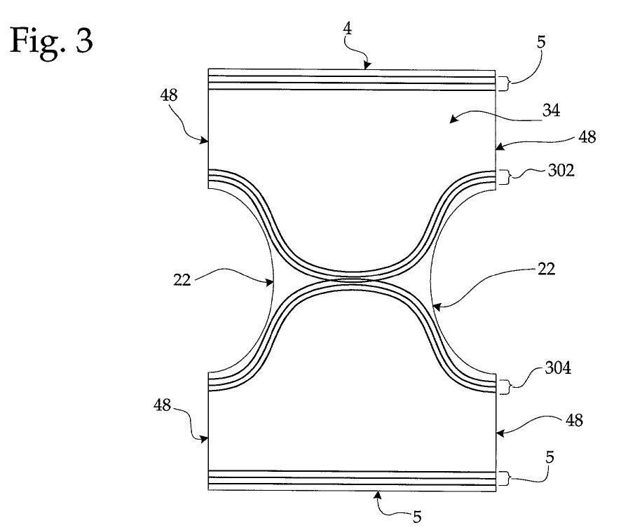

In another preferred embodiment, such as the embodiment shown in FIG. 3, additional elastics may be applied to the garment 10 along the leg cutouts 22. In such an embodiment, a first set of elastics 302 may be attached around one half of a leg cutout 22, stretched across the middle of the garment 10, then attached around one half of the opposite leg cutout 22 in a sinusoidal pattern or other pattern, and a second set of elastics 304 may be applied in a similar manner to the other halves of the leg cutouts 22. The first and second sets of elastics 302, 304 may or may not overlap. Also, the first and second sets of elastics 302, 304 may also be severed between the leg cutouts 22 to improve the garment's appearance and fit. Such elastics are known in the art, and disclosed, for example, in U.S. Pat. No. 5,634,917 issued to Fujioka et al. and U.S. Pat. No. 5,836,931 issued to Toyoda et al., which are incorporated herein by reference in their entirety, and in a manner consistent with the present invention.

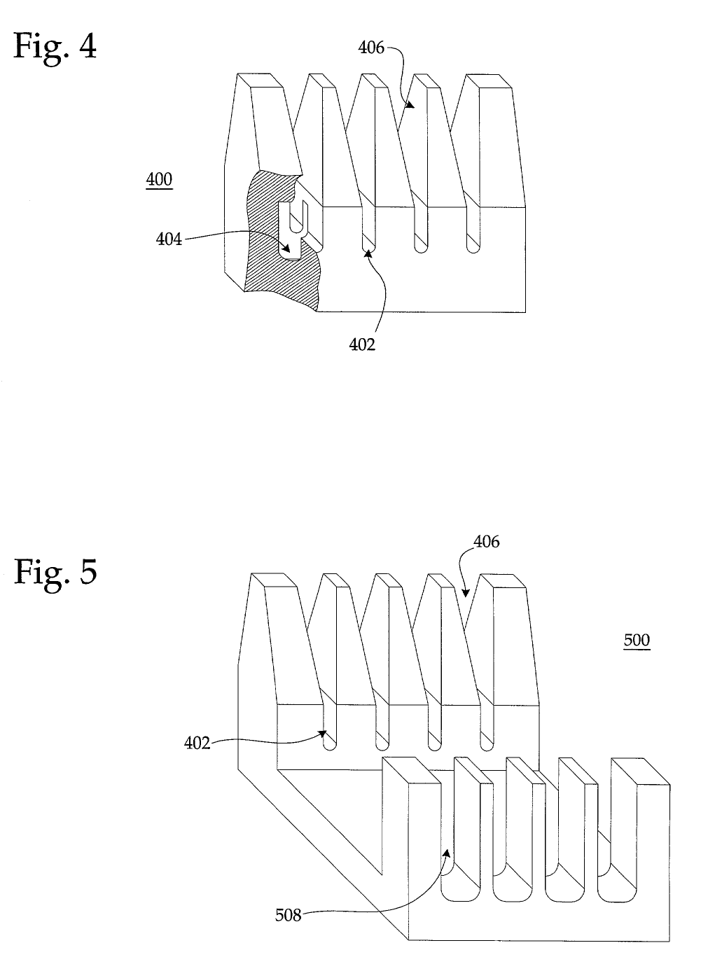

The elastics 3, 5, 6 or any other elastics may be joined to the garment 10 by the use of a flexible adhesive such as HL 1486UZP, which is available from H. B. Fuller Company of St. Paul, Minn. In a preferred embodiment of the invention, the adhesive is applied to the elastics 3, 5, 6 by passing the elastics through a comb applicator 400, such as the one depicted in FIG. 4. The comb applicator 400 has one or more slots 402 through which individual elastic strands pass. Each slot is connected to an adhesive passage 404 through which adhesive is applied to the elastic strands. In operation, adhesive is heated (if necessary) and pumped or otherwise supplied or provided into the adhesive passages 404 to coat the elastic strands. The slots 402 shown in the Figures herein preferably have substantially parallel walls and a substantially semicircular bottom wall, but other shapes may be used, as will be apparent to those skilled in the art. Also in the embodiments depicted herein, the comb applicator 400 is depicted as having four slots arranged in a substantially straight line, however it should be readily apparent to those skilled in the art that fewer or more slots may be employed and the slots may be staggered relative to one another. The slots 402 may optionally be equipped with tapered entrances 406 to facilitate positioning the elastic strands within the slots 402.

Referring to FIG. 5, the comb applicator may also optionally have a guide 508 on its entrance side that helps direct elastic strands into the slots 402 and reduce erratic movements of the elastic strands. Such a guide 508 may be particularly useful in an embodiment in which the comb applicator is moved laterally to guide the elastic strands through a variable path, such as the path of the leg elastics 302 and 304 in FIG. 3. A guide may also be positioned at the exit of the comb applicator 400.

The shape and size of the slots 402 is important for obtaining the desired adhesive coating pattern on the elastic strands. In a preferred embodiment, the adhesive fully coats the strands with adhesive around their entire periphery. The exact dimensions of each slot that may be used to obtain the desirable adhesive coating may depend on, for example, the size, e.g., the denier or diameter, of the elastic strand being coated, the degree of stretch of the elastic strand (to the extent that the stretch relates to the diameter of the strand), the length of the slots 402, the speed at which the elastic strand is moving, the viscosity and flow rate of the adhesive and the orientation of the comb applicator 400. One skilled in the art will be able to produce a suitable comb applicator 400 and adhesive application process without undue experimentation using the teachings provided herein.

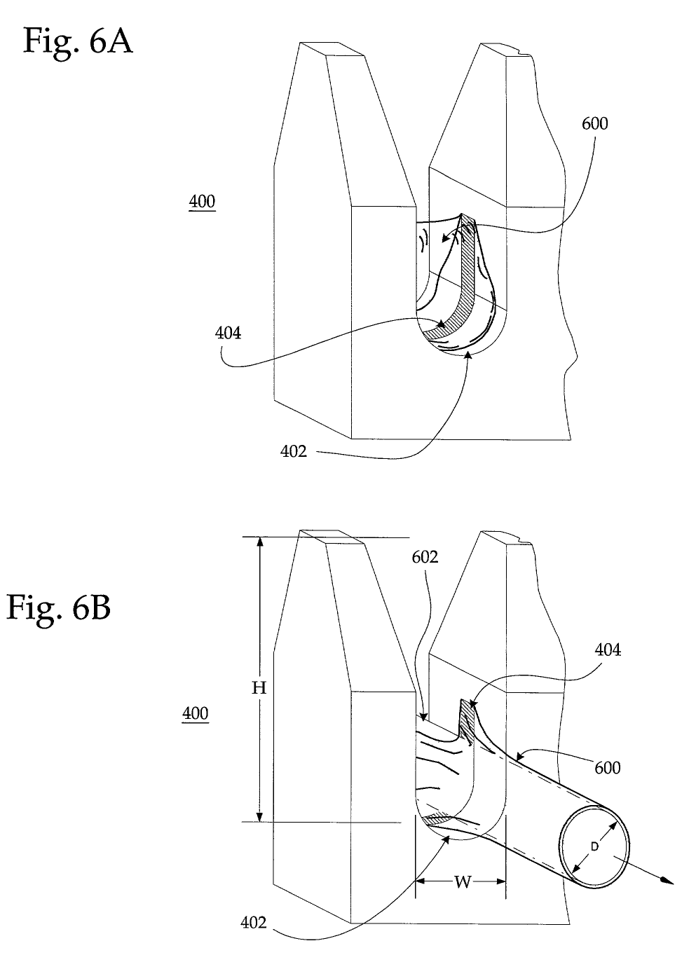

The operation of the comb applicator may be better understood with reference to the exemplary depictions of an embodiment of the present invention shown in FIGS. 6A and 6B. In FIG. 6A, a comb applicator 400 is shown with a curtain of adhesive 600 emerging from the adhesive passage 404 to partially or wholly fill the slot 402. During a preferred mode of operation, shown in FIG. 6B, an elastic strand 602 is immersed in the adhesive 600 and drawn in the direction indicated by the arrow. The adhesive 600 coats the elastic strand 602 around its entire periphery as the elastic strand 602 is pulled through the comb applicator 400.

As noted before, a number of variables will affect the degree to which the preferred coating is obtained. If the slot is too wide (dimension W in FIG. 6B) relative to the strand's periphery, e.g., diameter (dimension D in FIG. 6B), then an excessive amount of adhesive may pass through the adhesive passage 404, leading to, for example, wasted adhesive, clogging in the slot 404 and undesirable adhesive accumulations on other parts of the machinery and the garment. In a preferred embodiment, the slots 402 have a width W of about 0.005 inches (in) to about 0.050 in, and more preferably, the slots 402 have a width W of about 0.010 in to about 0.030 in, and most preferably, the slots 402 have a width W of about 0.015 in. Larger slots 402 may also be used for larger diameter elastic strands 602.

The height (dimension H in FIG. 6B) of the slots 402 may also affect the degree to which the preferred coating is obtained. If the height H is too low, the elastic strands 602 may lift out of the supply of adhesive 600 due to vibrations or other disturbances and not receive the desired adhesive coating. If the adhesive passage 404 is too tall, excess adhesive may accumulate within the slot, degrading performance and requiring more frequent service. In a preferred embodiment, the adhesive passages 404 have a height H of about 0.050 in to about 0.105 in, and more preferably, the adhesive passages 404 have a height H of 0.065 in to about 0.090 in, and most preferably, the adhesive passages 404 have a height H of about 0.079 in.

It has been found that elastic strands 602 having a denier of about 200 to about 2200, more preferably of about 400 to about 2000, and most preferably of about 600 to about 1800, may be used with the above-described slots.

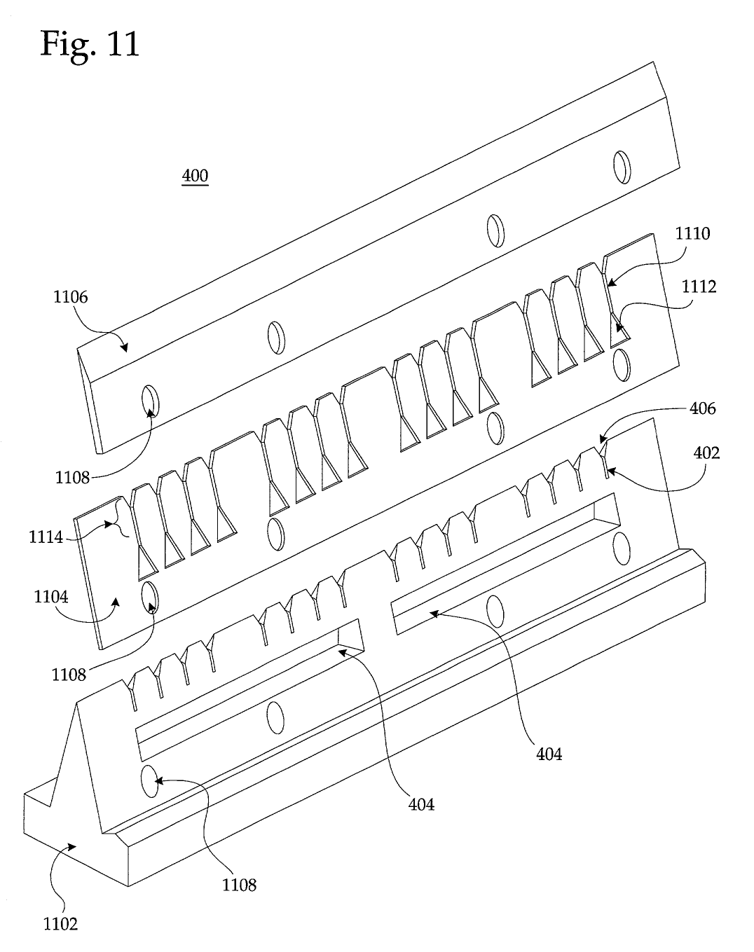

Referring now to FIG. 11, the design of the adhesive passage 404 may also influence the distribution of adhesive onto the elastic strands 602. For example, FIG. 11 depicts an exploded view of a preferred embodiment of a comb applicator 400 having sixteen slots 402. The comb applicator 400 comprises a base plate 1102 that is notched to form at least part of each of the slots 402 and their corresponding tapered entrances 406. The base plate 1102 also has two separate adhesive passages 404 within it, which may be fed by a common source or different sources. In use, a feed shim 1104 is sandwiched between the base plate 1102 and a clamping strip 1106. The base plate 1102, feed shim 1104 and clamping strip 1106 may be held together using screws that pass through screw holes 1108, clamps, or any other suitable fastening device.

The feed shim 1104 has a feed port 1110 and feed gallery 1112 corresponding to each slot 402. In operation, adhesive passes from the adhesive passages 404, into the feed galleries 1112, and through the feed ports 1110. Each feed port 1110 may terminate at the base of its corresponding slot 402, or may extend upward to form part of the slot 402. For example, as shown in FIG. 11, the upper portion 1114 of each feed port 1110 is shaped to have the same profile as the corresponding slot 402, and when the comb applicator 400 is fully assembled the upper portions 1114 of the feed ports 1110 form part of the slots 402. The clamping strip 1106 seals the assembly so that adhesive may only pass out through the feed ports 1110.

In the embodiment of FIG. 11, the amount of adhesive passing to each slot 402 may be regulated by changing the thickness of the feed shim 1104, with a thicker feed shim 1104 supplying more adhesive than a thin feed shim 1104. The relative amount of adhesive flow between each of the slots 402 may be regulated by making the feed ports 1110 supplying certain slots 402 narrower or wider than those supplying other slots 402. Such a relative difference in the amount of adhesive flow may be desirable to provide a greater amount of adhesive to slots 402 being used to coat larger elastic strands 602. In addition, it may be desirable to make some feed ports 1110 wider than others to equalize uneven adhesive flow caused by some slots being located farther from the adhesive source than others. The design of adhesive passages 404 and feed ports 1110 to obtain these and other goals is generally known in the art, and a skilled artisan will be able to design appropriate adhesive passage 404 and feed port 1110 systems without undue experimentation based on the teachings provided herein.

The length of the slot 402 may also affect the performance of the present invention. Longer slots 402 may prevent adhesive from being sprayed out of the slots and onto the assembly or the surrounding machinery. Longer slots may also allow more adhesive 600 to be pooled around the elastic strands 602 to provide more consistent coating. In one embodiment, the slots 402 have a length of about 0.010 in to about 0.065 in, and more preferably a length of about 0.022 in to about 0.052 in, and most preferably a length of about 0.037 in.

The diameter D of the elastic strand 602 may be reduced by providing the strand 602 with additional stretch. In some cases, the elastic strand 602 may require a minimum amount of stretching in order to pass through the slot 402 and obtain the desired adhesive coating. In one embodiment, the elastic strands 602 are stretched to about 250% to about 400% of their original length when they are passed through the slots 402, and more preferably, the elastic strands 602 are stretched to about 275% to about 375% of their original length when they are passed through the slots 402, and most preferably, the elastic strands 602 are stretched to about 300% to about 350% of their unstretched length when they are passed through the slots 402.

The elastic strands 602 may also have a non-circular shape, such as an elliptical or rectilinear or other shape, that may have one or more long axes and one or more short axes. In such a case, it may be desirable to ensure that the aspect ratio (as measured by the long axis size divided by the short axis size) is not so great as to inhibit the ideal coating of the elastic. In a preferred embodiment, the aspect ratio is between about 3:1 to about 1:1. In a more preferred embodiment, the aspect ratio is about 2:1 to about 1:1.

The speed at which the elastic strand 602 is drawn through the slot 402 may also affect the adhesive coating process. If the strands 602 are moving too fast, then they may receive an insufficient amount of adhesive coating, and may spray adhesive outside the comb applicator 400, causing undesirable adhesive build-up on other parts of the machine or the assembly. If the strands are moving too slow, then they may receive too much adhesive, and unapplied adhesive may flow out of the comb applicator 400 and build up on the surrounding machinery and assembly.

The speed of the elastic strands 602 should be matched to the viscosity and flow rate of the adhesive 600. Lower viscosity adhesives may tend to drain out of the comb applicator 400 or be sprayed by the elastic strand 602 to build up on other parts of the machinery or the assembly. Higher viscosity adhesives may resist full application around the periphery of the elastic strands 602 and may tend to harden and clog in the slots 402. The viscosity of the adhesive 600 may generally be varied by heating or cooling the adhesive 600 or by providing a different adhesive 600. In a preferred embodiment, the adhesive is H. B. Fuller Company's HL 1486UZP which is supplied in the comb applicator 400 at a temperature of about 250 degrees Fahrenheit to about 350 degrees Fahrenheit, or more preferably at about 275 degrees Fahrenheit to about 325 degrees Fahrenheit, and most preferably at about 290 degrees Fahrenheit to about 310 degrees Fahrenheit.

The flow rate of the adhesive may also impact the adhesive application process. The desired flow rate may be calculated by determining the volume of adhesive 600 that is desired to be applied to a given length of the elastic strand 602, then scaling this value to match the speed of the elastic strand 602. Once this value is determined, other variables, such as the viscosity of the adhesive 600, the temperature at which the adhesive is supplied, and so on, may be varied to obtain an ideal adhesive coating.

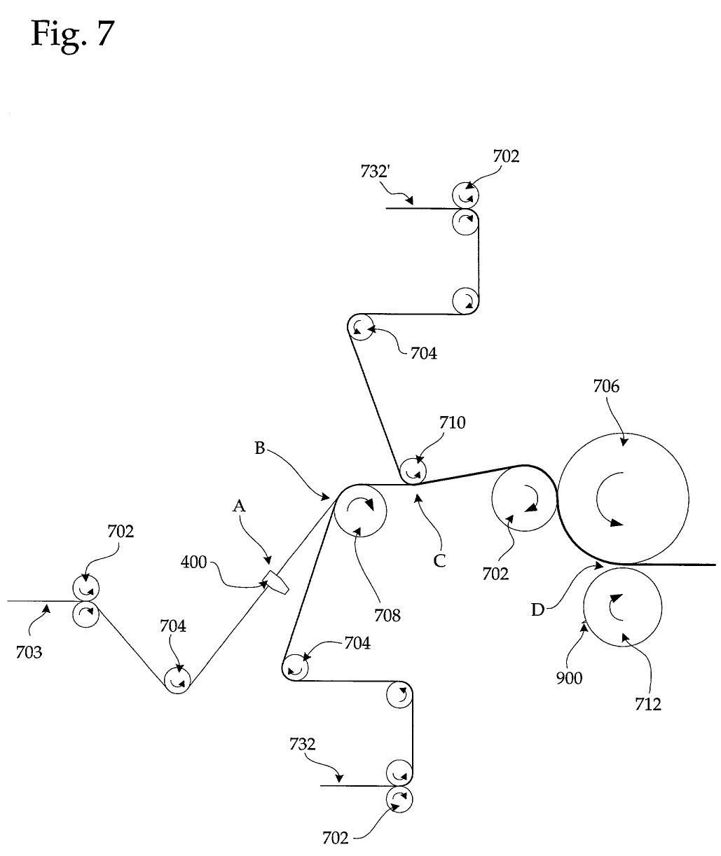

It has been found that the comb applicator 400 of the present invention may be operated in any orientation, with or without adjustment to the other variables, but that some orientations may provide better adhesive coating than others. In a preferred embodiment of the invention, the comb applicator 400 is angled downwardly (i.e., with the open ends of the slots 402 pointing downwardly, as shown in FIG. 7) at an angle of about 5 degrees to about 85 degrees, and more preferably at about 30 degrees to about 60 degrees, and most preferably at about 45 degrees. Similar upward orientations are also desirable in another preferred embodiment. Excess adhesive, if any, may be collected on a drip pan (not shown) located beneath the comb applicator, and such collection may be facilitated by orienting the comb applicator at a downward angle.

A suitable comb applicator that may be used with the present invention is supplied by Suntool of Osaka, Japan.

It may be desirable to apply adhesive to the elastics 3, 5, 6 only along a portion of their lengths, so that the portions of the elastics 3, 5, 6 do not receive any adhesive coating and do not adhere to the garment. In one embodiment of the invention this may be accomplished by intermittently cutting off the supply of adhesive 600 in the adhesive passages 404. In one preferred embodiment, a pump that supplies adhesive to the comb applicator may be equipped with a backflow device that draws adhesive out of the slots 402 and into the adhesive passages 404 so that the adhesive no longer contacts elastics 3, 5, 6. Such a backflow device may allow for relatively precise cutoff of the adhesive application, providing easier use and reducing inadvertent adhesive application. Other methods of cutting off the adhesive supply to the elastic strands include simply cutting off the flow of adhesive 600 or momentarily lifting the elastic strands out of the slots by using, for example, a reciprocating guide or a rotating cam with a lifting lobe. Other methods of momentarily ceasing the application of adhesive to the strands will be evident to those skilled in the art in light of the teachings herein.

The adhesive coating of the present invention provides significant benefits over the currently known adhesive coating techniques. The adhesive coating techniques of the prior art used multiple pressurized spray guns to eject adhesive onto the elastic strands, leading to excessive adhesive usage and undesirable overspray. Such techniques also do not fully and uniformly coat the elastic strands, thereby providing a weaker bond with the underlying sheet material to which the elastic strands are attached. Using the present invention, the elastic strands are substantially fully and uniformly coated with adhesive following immersion in the adhesive-filled comb applicators 400, thereby providing a stronger and therefore superior finished garment. Furthermore, there is no adhesive overspray onto the outer nonwoven material or the assembly machine, and the resulting garment is softer due to the absence of hard spots from hardened oversprayed adhesive on the various garment materials.

Referring now to FIG. 7, a preferred method for applying elastics to a garment is described. In a preferred embodiment depicted in FIG. 7, continuous supplies of first and second carrier layer material 732, 732′ are supplied. A continuous supply of one or more elastic strands 703 is supplied to be fed between the first and second supplies of carrier layer material 732, 732′. The supplies of carrier layer material and elastic strands 732, 732′, 703 may be held by pinch rollers 702 and tensioned by adjustable tensioning rollers 704 to obtain the desired position, speed and tension in each supply. A drive roller 706 may be used in conjunction with a pinch roller 702 to pull the supplies 703, 732, 732′ through the machinery. The drive roller 706, like the other rollers, may serve other functions, such as to simultaneously serve as an anvil roller against which a knife 900 presses to cut all or part of the supplies of elastic strands 703 and supplies of carrier layer material 732, 732′ as described below.

At location A, a comb applicator 400 applies adhesive to the supply of elastic strand 703, as described above. Using the present invention, the comb applicator 400 may be located near one or both of the supplies of carrier layer material 732, 732′ without any adhesive being sprayed onto those materials. At location B, a first side of the supply of elastic strands 703 contacts the first supply of carrier layer material 732 as the two supplies are drawn across a first guide roller 708. At location C, the second supply of carrier layer material 732′ is pressed against the second side of the supply of elastic strands by a second guide roller 710, which may be adjustable to apply the second supply of carrier layer material 732′ with more or less pressure. After location C, the now complete elasticized laminate structure may be conveyed to other parts of the assembly line to be processed into standing leg gather assemblies, waist elastic assemblies, tummy elastic assemblies or other elastic assemblies that are incorporated into an absorbent garment. Such further processing is generally known by those skilled in the art. It should also be apparent to one skilled in the art that the above described steps may be transposed or altered in a number of ways to achieve the same end result, for example, the supply of elastic strands 703 may be applied to the second supply of carrier layer material 732′ before being applied to the first supply of carrier layer material 732, or other devices may be used to tension, stretch, position, and drive the various material supplies. Such variations are within the scope of this invention.

In another embodiment of the invention, a comb applicator 400 may be used to supply adhesive to a supply of one or more elastic strands that are placed on a single supply of material that is folded over on itself to form an elasticized ribbon, such as those often used to make standing leg gathers 30, or form an elasticized edge of a sheet, such as to form elasticized waist or edges or leg cutouts.

In another preferred embodiment, a comb applicator 400 is used to incorporate elastic strands into a tummy elastic assembly 52 comprising first and second carrier layers 32, 32′ having one or more tummy elastics 3. The tummy elastic assemblies 52 may then be applied to one or both longitudinal ends 4 of the chassis layer 34. The tummy elastics 3 may extend across the entire width of the garment 10, or they may extend only partially across the garment's width.

It has been found that to improve the garment's fit and aesthetic appeal it may be desirable to provide tummy elastics only along either side of the garment 10, and not across the middle of the garment 10 where the absorbent core 16 is located. One method for producing such a preferred embodiment is to use tummy elastic assemblies 52 that are only elasticized in those regions overlaying the sides of the garment, as shown in FIG. 2. Such an tummy elastic assembly 52 may be easily produced using the present invention, and such a process is described now with reference to FIGS. 7-10.

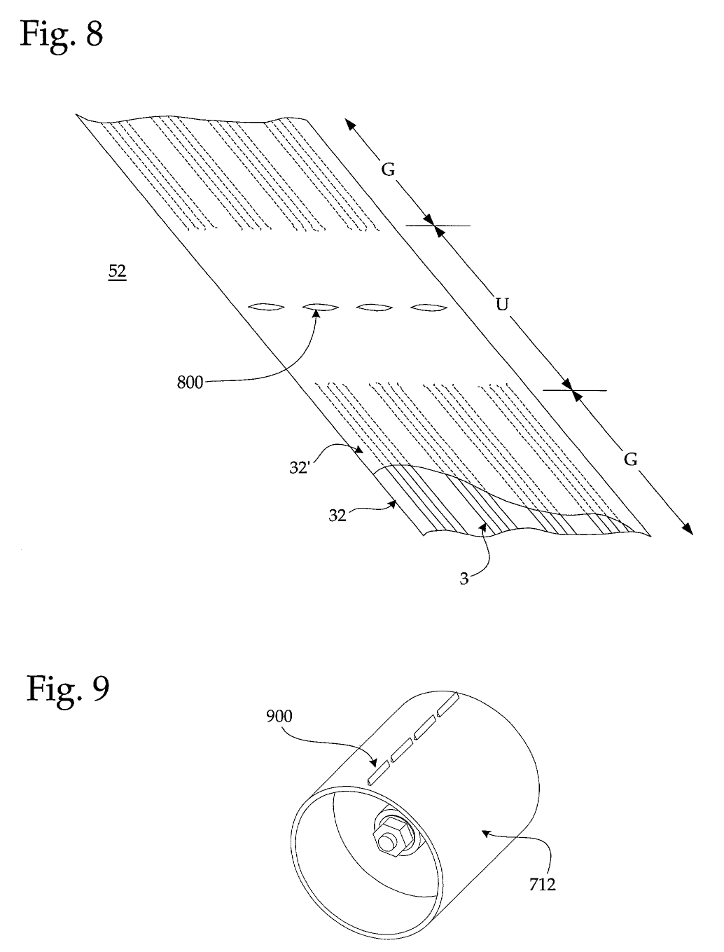

In order to produce a tummy elastic assembly 52 having discontinuous elastics, the tummy elastics 3 may be discretely coated along portions of their length so that they adhere to the first and second carrier layers 32, 32′ in glued zones G, but do not adhere to the carrier layers 32, 32′ in unglued zones U, as indicated in FIG. 8. The tummy elastics 3 are then severed in each unglued zone U by a notched knife 900 attached to a cutting drum 712, such as is shown in FIG. 9. The notched knife 900 forms cuts 800 in only those portions of the carrier layers 32, 32′ that have tummy elastics 3 located there between, so that the carrier layers 32, 32′ still continue along the assembly line as continuous supplies of material that are joined to one another by the adhesive-coated tummy elastics 3. The cut ends of the tummy elastics 3 snap back out of the unglued zone U, thereby providing elastication in the glued zones G, but not in the unglued zones U. Such a process may take place immediately after the tummy elastic assembly 52 is formed, such as at location D of FIG. 7, or at any other suitable location. It has been found that in some cases the notched knife 900 does not have to fully sever the tummy elastics 3 and the carrier layers 32, 32′, and may instead simply press against the layers 32, 32′ with enough force to damage the tummy elastics 3 by crushing them, thereby causing them to separate.

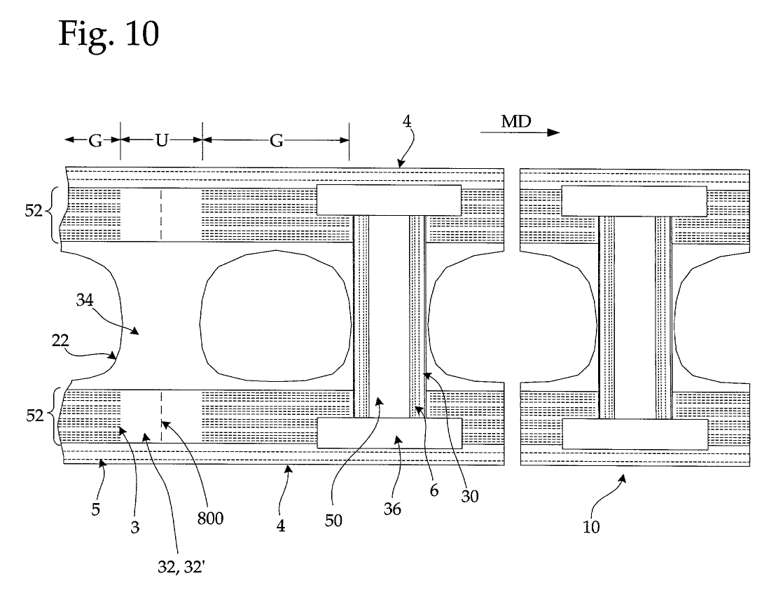

Referring now to FIG. 10, tummy elastic assemblies 52 may be attached proximal to each longitudinal end 4 of the chassis layer 34, as it moves in the machine direction (indicated by the arrow MD). Each tummy elastic assembly 52 is positioned such that the unglued (inelastic) zones U overlap the part of the chassis layer 34 to which the core assembly 50 will be attached, and the glued (elasticized) zones G overlap the portions of the chassis layer 34 that will eventually form the sides of the garment. The core assembly 50, which may comprise the topsheet 14, backsheet 12, absorbent core 16, transfer layer 20 and standing leg gathers 30, may then be positioned on the chassis layer 34 between the leg cutouts 22 (naturally the leg cutouts 22 may be made after positioning the core assembly 50). The ends of the core assembly then may be secured to the garment by overlapping them with end strips 36. Embodiments of the present invention may also be used to apply other elastics to an absorbent garment, such as waist elastics 5, and gather elastics 6. Once the assembly is complete, discrete absorbent garments 10 may be severed from the assembly, or the assembly may be folded and bonded to form a continuous supply of pant-like garments which is then severed into discrete garments 10. Those skilled in the art will understand that other steps may be employed to fabricate a complete absorbent garment, and one or more of the preceding steps may be rearranged, omitted, substituted or modified.

Such an embodiment is particularly desirable because it allows the elastics to be located in discrete areas, rather than continuously along the entire garment width. By maintaining the first and second carrier layers 32, 32′ as a continuous supply of material, this method does not require the use of complex manufacturing techniques that are normally required to place discrete elasticized parts into a garment. Of course, it may be desirable to provide elastication completely across the stomach region, in which case the tummy elastics 3 may be adhered along the entire width of the garment and not severed.

The following Example is illustrative only and is not intended to limit the present invention.

### EXAMPLE

A test garment was constructed according to a preferred embodiment of the present invention and compared with a conventional garment to determine their relative comfort and cost. Both the test garment and the conventional garment were constructed to be substantially similar to the embodiment disclosed in FIGS. 1 and 2, and each had tummy elastics 3, waist elastics 5, and gather elastics 6. The following test garment is exemplary only, and not intended to limit the scope of the present invention.

The tummy elastic assemblies 52 of the conventional garment each comprised sixteen tummy elastics 3, each made from a 610 denier LYCRA®XA®680 DECITEX spandex elastic strand (available from E. I. DuPont de Nemours and Co., of Wilmington, Del.) that were disposed between first and second carrier layers 32, 32′ to be substantially parallel to the lateral direction 102 of the garment 10 and substantially evenly spaced from one another. The total distance between the tummy elastics 3 was approximately 99 mm in the longitudinal direction 100. The carrier layers 32, 32′ each comprised a sheet of POLYBOND® nonwoven material (available from Polymer Group, Incorporated (PGI), headquartered in North Charleston, S.C.), having a basis weight of approximately 16 grams per square meter (g/m²). The tummy elastics 3 were stretched to about 350% of their original length prior to being incorporated into the tummy elastic assemblies 52. The tummy elastics 3 were discretely coated with adhesive prior to placement between the carrier layers 32, 32′ and were severed in the unglued regions U, as shown in FIG. 8, and described herein with reference to FIGS. 7-10 after being incorporated into the tummy elastic assemblies 52. About 0.63 grams of HL 1486UZP hot melt adhesive was applied to the tummy elastics 3 of the tummy elastic assemblies 52 using conventional NORDSON ATS SERIES 6-head adhesive applicators (available from Nordson Corporation of Norcross, Ga.). The conventional adhesive applicators (one for each tummy elastic assembly 52) projected a spiral spray pattern from each head of the applicator having a width of about 22.3 mm. The six heads of each applicator were spaced apart from one another (the pitch distance) by about 22.3 mm. Each tummy elastic assembly 52 was then adhered to the chassis layer 34 adjacent an opposite longitudinal end 4.

Three waist elastics 5 of the conventional garment were applied parallel to one another and in the lateral direction 102 in a fold along each longitudinal end 4 of the chassis layer 34. The waist elastics 5 were spaced from one another by about 9 mm. The folds completely covered the waist elastics 5 after they were applied. Each of the six waist elastics 5 comprised a 1680 denier Type S-7 GLOSPAN® spandex elastic strand (available from Radici Group of Fall River, Mass.). The chassis layer 34 comprised a nonwoven sheet of FQF®, available from First Quality Fibers of Hazelton, Pa., having a basis weight of approximately 20 g/m². Each set of three waist elastics 5 was extended to about 350% of its original length and coated with HL 1486UZP hot melt adhesive by the spiral spray procedure using a conventional NORDSON ATS SERIES 1-head adhesive applicator. Each applicator continuously sprayed adhesive in a spiral pattern having a width of about 25 mm to coat three of the waist elastics 5 just before they were placed on the chassis layer 34.

The gather elastics 6 of the conventional garment were incorporated substantially parallel to one another and in the longitudinal direction 100 of the garment 10 into the standing leg gathers 30. Each standing leg gather 30 had four gather elastics 6. The gather elastic 6 in each standing leg gather 30 that was closest to the topsheet comprised a 1680 denier Type S-7 GLOSPAN® spandex elastic strand, and the remaining three gather elastics 6 comprised 840 denier Type S-7 GLOSPAN® spandex elastic strands. Each standing leg gather 30 was assembled separately from the rest of the garment 10 by stretching the gather elastics 6 to about 259% of their original length, continuously coating them with HL 1486UZP hot melt adhesive and placing them onto a sheet of POLYBOND® nonwoven material having a basis weight of about 16 g/m². A conventional spiral spray applicator, such as those described above, was used to apply adhesive to the gather elastics 6. The sheet was then folded onto itself to encapsulate the gather elastics 6 and attached to the core assembly 50.

The remainder of the conventional garment 10 was constructed according to known methods.

A test garment was prepared in a nearly identical process as the conventional garment except that all the elastic elements were coated with adhesive according to an embodiment of the invention. In addition, each standing leg gather 30 of the test garment was constructed using seven 840 denier LYCRA®XA®940 DECITEX spandex elastic strands as the gather elastics 6.

Adhesive was applied to the tummy elastics 3, waist elastics 5, and gather elastics 6 of the test garment by passing them through a comb applicator 400 as shown in FIG. 5. Each elastic element was completely coated with melted adhesive while in the comb, and no other adhesive was applied to join the carrier layers 32, 32′ or to hold the folds in the chassis layer 34 and standing leg gathers 30.

The areas of the test garment and the conventional garment containing the elastic elements 3, 5, 6 were compared with one another by touch and manipulation to determine their relative softness and pliability. The test garment exhibited substantially more pliability and softness than the conventional garment, and the overall feel was more cloth-like than the conventional garment.

This improved pliability, softness and overall feel was due to the elimination of the “plywood effect” caused by oversprayed adhesive. The present invention practically eliminates the “plywood effect” by coating only the elastic strands, and not the underlying sheets of material. The coating on the elastic strands is sufficient to hold the elastic strands to the sheets and to thereby hold the sheets together during use. When the elastics contract, causing the garment to gather or “shirr,” the sheets are free to wrinkle or fold because they are no longer bonded to one another at any location other than around the elastic strands, and are no longer subject to the “plywood effect.”

In addition to providing improved softness and feel, the present invention provides a significant cost savings by reducing the amount of adhesive used to construct each garment. Tables 1 and 2 below compare the amount of hot melt adhesive required for the production of the conventional garment and the test garment.

Table 1
Conventional Garment - Spiral Spray Adhesive Application

| | # Elastic | Length | Total | g Adhesive | g Adhesive |
|---|---|---|---|---|---|
| | Strands | per | Strand | Used per | Used per m |
| Area | per Area | Strand, m | Length, m | Area | Elastic |
| Tummy | 32 | 0.245 | 7.84 | 0.63 | 0.0804 |
| Leg | 8 | 0.37 | 2.96 | 0.20 | 0.0676 |
| Gathers | | | | | |
| Waist | 6 | 0.375 | 2.25 | 0.33 | 0.1444 |

TABLE 2
Test Garment - Comb Applicator Adhesive Application

| | # Elastic | Length | Total | g Adhesive | g Adhesive |
|---|---|---|---|---|---|
| | Strands | per | Strand | Used per | Used per m |
| Area | per Area | Strand, m | Length, m | Area | Elastic |
| Tummy | 32 | 0.245 | 7.84 | 0.28 | 0.0357 |
| Leg | 14 | 0.28 | 3.92 | 0.15 | 0.0383 |
| Gathers | | | | | |
| Waist | 6 | 0.375 | 2.25 | 0.20 | 0.0444 |

A comparison of the amount of adhesive used in preparing the test garment and the conventional garment shows a reduction in adhesive usage per meter of elastic of 56% for the tummy area, 43% for the leg gathers, and 39% for the waist area. These reductions translate to direct cost savings for each article produced. Other benefits, such as reduced costs for cleaning the machinery, also accrue to one using an embodiment of the present invention.

Other embodiments, uses, and advantages of the invention will be apparent to those skilled in the art from consideration of the specification and practice of the invention disclosed herein. The specification should be considered exemplary only, and the scope of the invention is accordingly intended to be limited only by the following claims and equivalents thereof.

We claim:

1. A method for applying elastic to an absorbent garment comprising:
moving one or more elastic strands at a predetermined speed in a first direction through an applicator comb having one or more slots, each slot corresponding to a respective elastic strand;
providing adhesive to the applicator comb at a predetermined temperature and flow rate;
depositing the adhesive onto the one or more elastic strands to form an adhesive coating around substantially the entire periphery of each of the one or more elastic strands;
applying the one or more elastic strands to a first sheet;
applying a second sheet onto the first sheet such that the one or more elastic strands are between the first sheet and the second sheet.

2. The method of claim 1, wherein the adhesive does not contact the first sheet or the second sheet during the step of depositing.

3. The method of claim 1, wherein the one or more elastic strands form tummy elastics in the absorbent garment.

4. The method of claim 1, wherein the one or more elastic strands form waist elastics in the absorbent garment.

5. The method of claim 1, wherein the one or more elastic strands form gather elastics in the absorbent garment.

6. The method of claim 1, wherein the second sheet is a folded-over and continuous portion of the first sheet.

7. The method of claim 1, further comprising:
periodically discontinuing providing adhesive to the applicator comb for a predetermined amount of time; and
not depositing adhesive on the one or more elastic strands during the step of periodically discontinuing providing to thereby leave discrete portions of the elastic strands not coated with adhesive.

8. The method of claim 7, further comprising pulling adhesive away from the one or more elastic strands during the step of periodically discontinuing providing.

9. The method of claim 7, further comprising:
severing each of the one or more elastic strands in the discrete portions of the elastic strands not coated with adhesive after the strand has been applied to the first sheet.

10. The method of claim 1, wherein the first and second sheet are joined to one another only by mutual adhesion to the adhesive coating.

11. The method of claim 1, further comprising stretching the one or more elastic strands.

12. The method of claim 11, wherein the step of stretching comprises stretching the one or more elastic strands to about 250% to about 400% of their unstretched length.

13. The method of claim 11, wherein the step of stretching comprises stretching the one or more elastic strands to about 275% to about 375% of their unstretched length.

14. The method of claim 11, wherein the step of stretching comprises stretching the one or more elastic strands to about 300% to about 350% of their unstretched length.

15. The method of claim 1, wherein the step of moving one or more elastic strands comprises moving one or more elastic strands having a denier of about 200 to about 2200.

16. The method of claim 1, wherein the step of moving one or more elastic strands comprises moving one or more elastic strands having a denier of about 400 to about 2000.

17. The method of claim 1, wherein the step of moving one or more elastic strands comprises moving one or more elastic strands having a denier of about 600 to about 1800.

18. An absorbent garment subassembly comprising:
a first sheet;
a second sheet;
one or more elastic strands disposed between the first sheet and the second sheet;
an adhesive coating disposed around substantially the entire periphery of each elastic strand along at least part of each elastic strand's length.

19. The absorbent garment subassembly of claim 18, wherein the first sheet and the second sheet are joined to one another only by the adhesive coating.

20. The absorbent garment subassembly of claim 18, wherein the absorbent garment subassembly is a standing leg gather assembly and the first sheet and the second sheet are continuous portions of a single folded sheet.

21. The absorbent garment subassembly of claim 18, wherein the absorbent garment subassembly is a chassis layer and the first sheet and the second sheet are continuous portions of a folded sheet.

22. The absorbent garment subassembly of claim 18, wherein the absorbent garment subassembly is a tummy elastic assembly.

23. The absorbent garment subassembly of claim 22, wherein the adhesive coating on each of the elastic strands is disposed proximal to each end of the tummy elastic assembly and not disposed in a central region there between, and the elastic strands are severed in the central region.

24. The garment of claim 18, wherein the adhesive coating is disposed on each elastic strand by immersing the elastic strands in an applicator comb containing melted adhesive and drawing the elastic strands through the applicator comb.

25. The article of claim 18 wherein at least some of the elastic strands are selected from the group consisting of rubber, spandex, elastic polymers, elastic film, elastic foam materials, elastic webbing, elastic netting, and scrim elastic.

26. An absorbent garment manufacturing system comprising:
a first path for supplying a first layer of material;
a second path for supplying a second layer of material;
a third path for supplying one or more elastic strands;
an applicator comb, disposed along the third path, for applying adhesive to the one or more elastic strands;
wherein the elastic strands are in registration with the applicator comb so that the applicator comb provides adhesive directly onto the periphery of the elastic strands and the applicator comb does not directly deposit a substantial amount of adhesive on the first layer of material or the second layer of material or onto other parts of the absorbent garment manufacturing system.
